(19) United States
(12) Patent Application Publication
(10) Pub. No.: US 2015/0144072 A1
(43) Pub. Date: May 28, 2015

(54) MODULAR LEASH ACCESSORY SYSTEM

(71) Applicant: Carol Whitefield, De Pere, WI (US)

(72) Inventor: Carol Whitefield, De Pere, WI (US)

(21) Appl. No.: 14/555,624

(22) Filed: Nov. 27, 2014

Related U.S. Application Data
(60) Provisional application No. 61/909,415, filed on Nov. 27, 2013.

(51) Int. Cl. A01K 27/00; A45F 5/00

(52) U.S. Cl. CPC A01K 27/008; A01K 27/003; A45F 5/00; A45F 2005/002
USPC 119/795; 224/191; 224/905

(57) ABSTRACT

A modular leash accessory system includes a first pouch having an interior compartment and an exterior surface. The first pouch is securable to an animal leash. A second pouch having an interior compartment is releasably and operatively secured to the first pouch

This application is a U.S. Non-Provisional application claiming priority to U.S. Provisional Application No. 61/909,415, filed Nov. 27, 2013, entitled “MODULAR LEASH ACCESSORY SYSTEM” of which is incorporated herein by reference in its entirety.

### BACKGROUND OF THE INVENTION

The present invention relates generally to the field of pet novelty products and more specifically to a canine accessory transport system that attaches to a dog leash.

Many Americans own pets and spend money on pet accessories. Novelty products enjoy a robust market in the pet industry, and larger retailers seek to fill billions of dollars of shelf space.

Many pet owners walk or run with their pets, and carry one or more of the following accessories with them: waste disposal bags, keys, phones or personal device with music, headphones, identification, money, pet treats and hand sanitizer.

It is desirable to have a pet accessory system which allows a user to customize the apparatus based on the particular accessories the runner or walker needs on a particular trip.

It is further desirable to allow a user to take more or fewer accessories.

It is further desirable to have a discreet and odor and impact resistant means to carry pet refuse which does not disrupt a run.

### SUMMARY OF THE INVENTION

One embodiment of the present invention relates to the modular system of components which may be securely and selectively attached to a dog leash to allow a runner or walker to continue running or walking with their dog without disruption or losing momentum because they have to carry these items.

### BRIEF DESCRIPTION OF THE DRAWINGS

FIG. 1 illustrates a canine accessory transport system with a detachable small accessory pouch and a detachable waste pouch with removable waste receptacle insert.

FIG. 2 illustrates a detachable waste pouch with removable waste receptacle insert.

FIG. 2b illustrates a detachable small accessory pouch with a waste bag dispenser and an accessory pocket.

FIG. 2c illustrates a detachable large accessory pouch with a waste bag dispenser, accessory pocket, and phone pocket.

FIG. 3 illustrates the snap fasteners that are used to attach various pouches to the leash.

FIG. 4 is an isometric view of another embodiment of a modular leash system.

FIG. 5 is an exploded view of the modular leash system of FIG. 4.

FIG. 6 is a front view of the modular leash system of FIG. 4.

FIG. 7 is a top view of the modular leash system of FIG. 4.

FIG. 8 is a bottom view of the modular leash system of FIG. 4.

FIG. 9 is a side view of the modular leash system of FIG. 4.

FIG. 10 is an isometric view of one pouch with the flap in the open position of the modular leash system of FIG. 4.

FIG. 11 is a top isometric view of the first pouch and second pouch being held by a hand about the first cross handle and second cross handle.

FIG. 12 is an isometric view of another embodiment of a handle for use with a retractable leash.

FIG. 13 is an exploded view of the modular leash system of FIG. 12.

### DETAILED DESCRIPTION OF THE PREFERRED EMBODIMENTS

For the purpose of promoting an understanding of the present invention, references are made in the text to exemplary embodiments of a canine accessory transport system, only some of which are described herein. It should be understood that no limitations on the scope of the invention are intended by describing these exemplary embodiments. One of ordinary skill in the art will readily appreciate that alternate but functionally equivalent canine accessory transport system may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

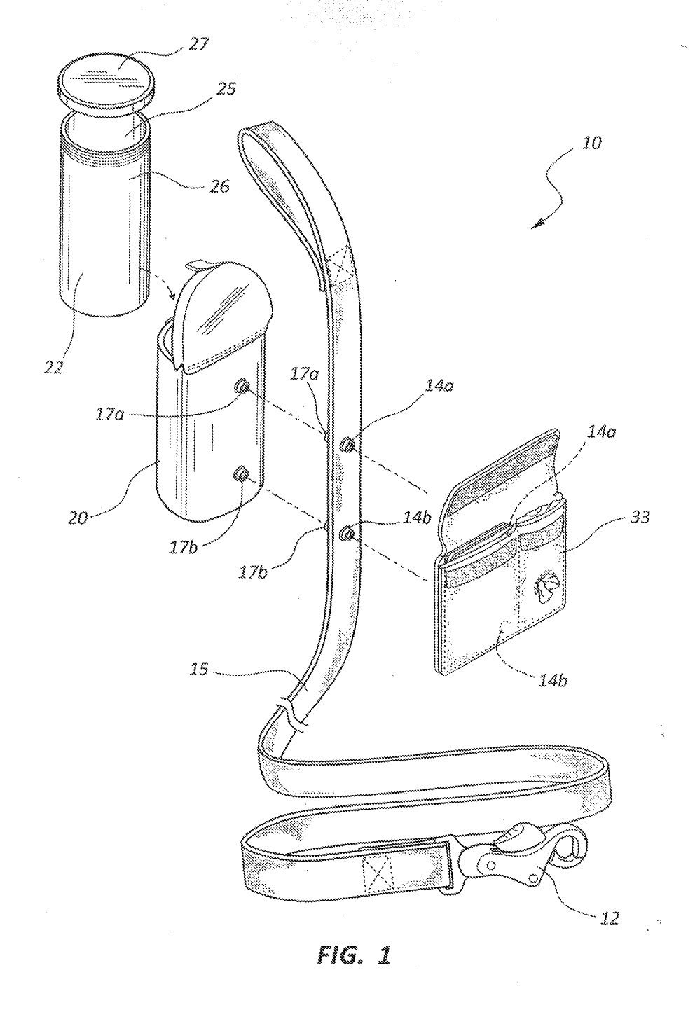

FIG. 1 illustrates an exemplary embodiment of a canine accessory transport system 10 with small accessory pouch 33 and waste pouch 20 with waste receptacle insert 20. Pouches are fabricated from a soft, light fabric material such as neoprene. In the embodiment shown, small accessory pouch 33 attaches to leash 15 on one side, and waste pouch 20 with waste receptacle insert 22 attaches to leash 15 on the other side. The waste receptacle insert 22 is plastic, metal or fiberglass and is impact resistant. It has a wide-mouth aperture 25, a rigid waste chamber 26 and a sealed cap component 27. Each pouch is attached to the leash with a pair of snap fasteners 14a-14b and 17a-17b (not shown).

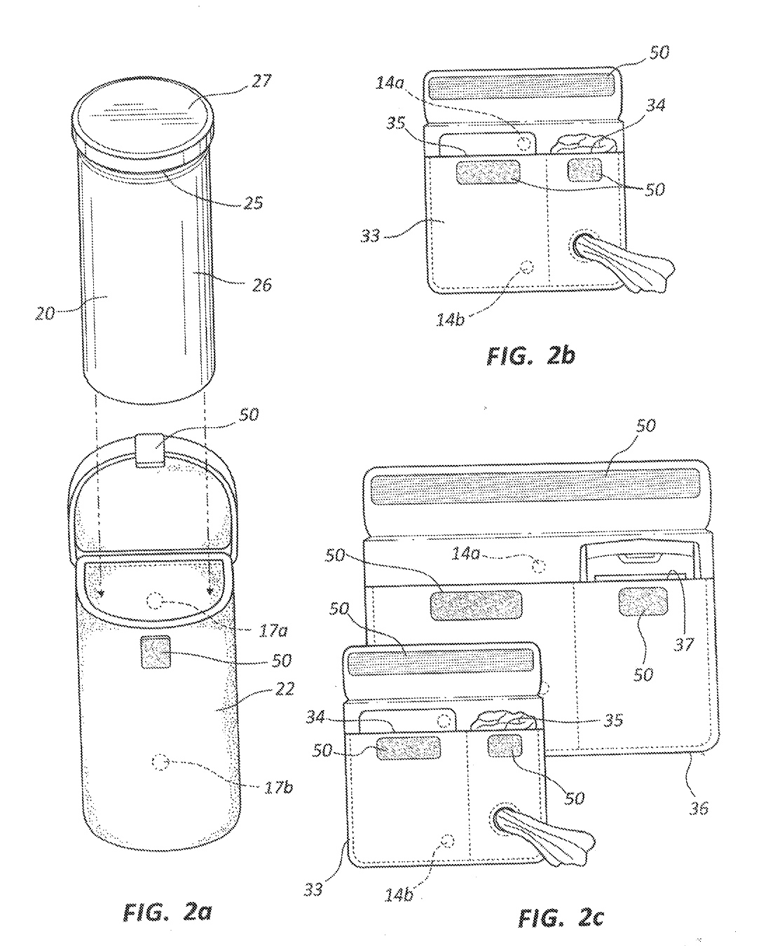

FIGS. 2a-2c illustrate exemplary embodiments of waste pouch 20 with waste receptacle insert 22, small accessory pouch 33 and large accessory pouch 36. Small accessory pouch 33 contains a stitch that separates the inside into two sections: a waste bag dispenser 34 and an accessory pocket 35 that can be used to store keys, ID, dog treats, etc. Large accessory pouch 36 is a combination of two separate pouch sections that are attached to each other; a smaller section with the same compartments as seen in the small accessory pouch 33, and a larger phone pocket 37 section that is designed to store a cell phone. In these exemplary embodiments, all of the pouches are secured shut with hook and loop fastener 50 (Velcro).

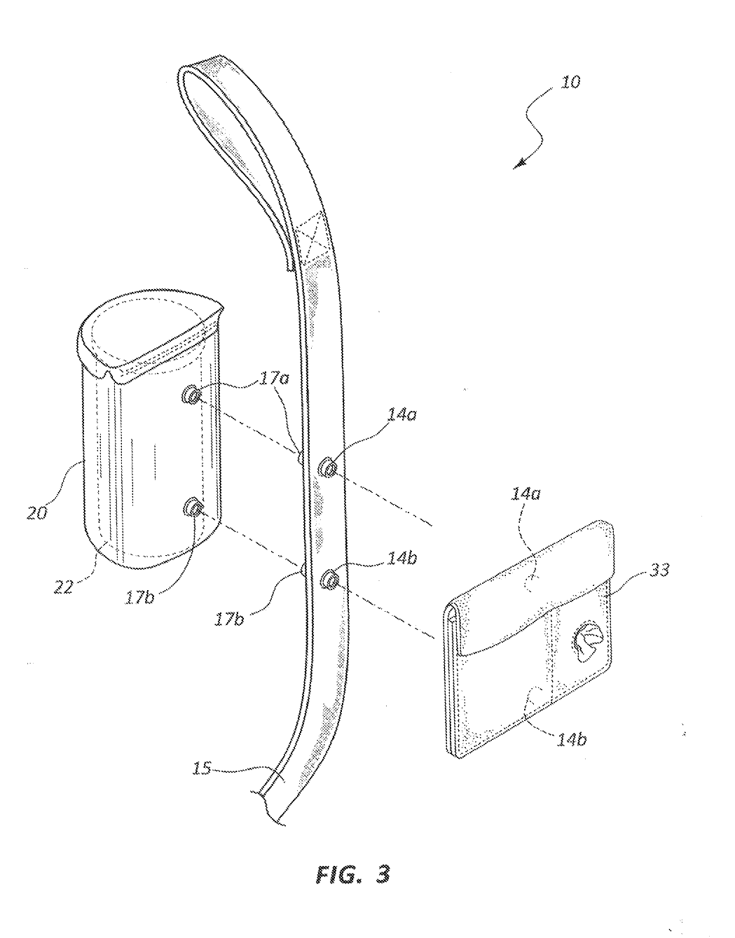

FIG. 3 illustrates how a waste pouch 20 and a small accessory pouch 33 attach to leash 11 with snap fasteners for waste pouch 17a, 17b and snap fasteners for small accessory pouch 14a, 14b. Small accessory pouch 33 can be substituted with large accessory pouch 36 (not shown) at the user's discretion. Other pouches specially designed to carry items such as food, water or toys may be developed and substituted for the pouches in this exemplary embodiment, as this is a modular system.

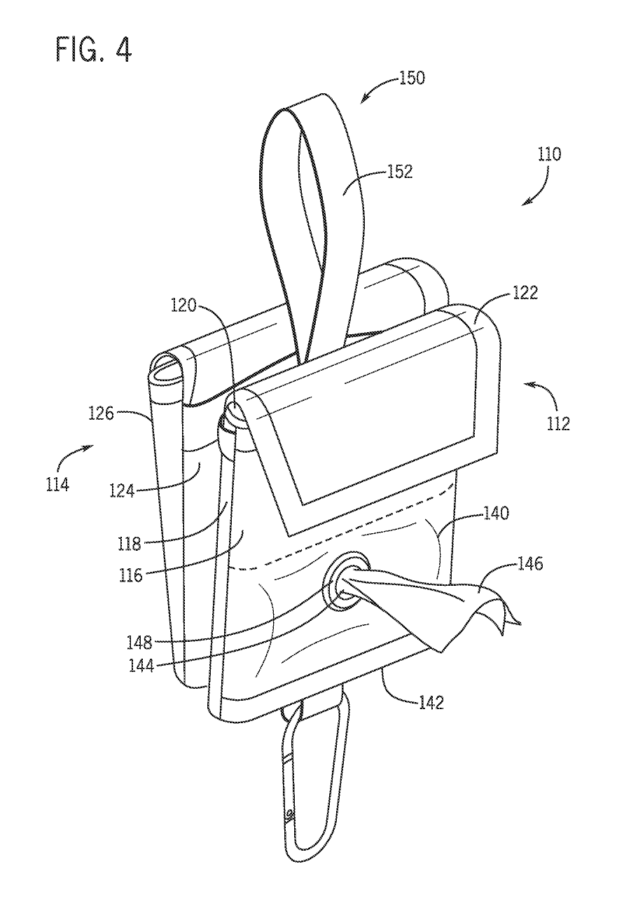

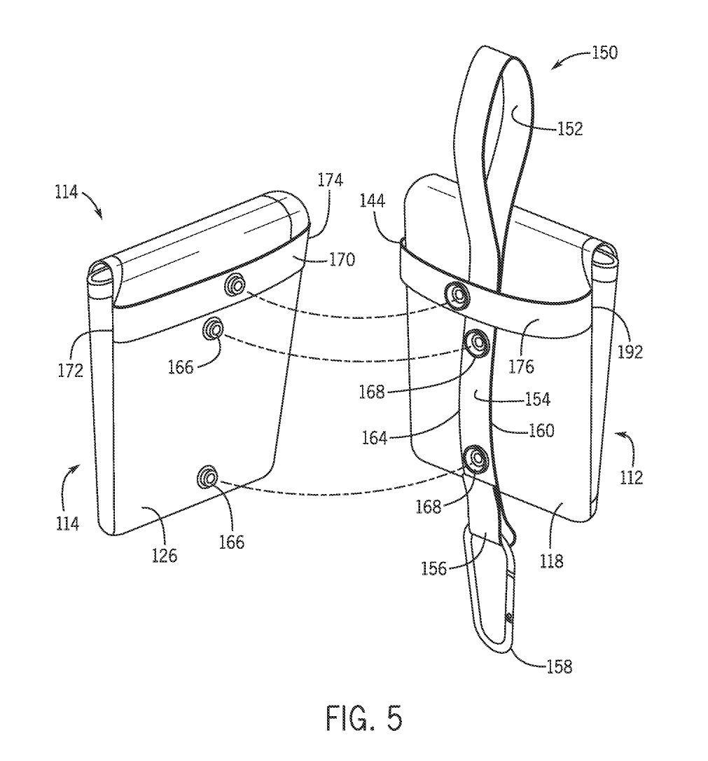

Referring to FIGS. 4 and 5 a modular leash system 110 includes a first pouch 112 having an interior compartment and an exterior surface, the first pouch 112 is securable to an animal leash 113. A second pouch 114 includes an interior compartment. The second pouch 114 is releasably and operatively secured to the first pouch 112. one embodiment at least one of the first pouch 112 and second pouch 114 is formed from a flexible material. In one embodiment the flexible material is neoprene. In one embodiment both the first pouch 112 and second pouch 114 are formed from a flexible neoprene material.

First pouch 112 includes a first panel 116 and a second panel 118. In one embodiment first panel 116 and second panel 118 are secured together as is known in the art. In one embodiment first panel 116 and second panel 118 may be sonically welded, stitched with a thread material, chemically bonded with an adhesive or any other method known in the art. In one embodiment first panel 116 and second panel 118 are formed from a single piece of material that is folded over along one edge. The interior compartment of first pouch 112 is defined by the space between the front portion 116 and the rear portion 118. A top opening 120 is defined by the upper edge 122 of first panel 116 that extends from and away from second panel 118. In one embodiment, first pouch 112 includes a flap 122 extending from second panel 118 and extends over and covers opening 120 and an upper region of first panel 116.

Second pouch 114 includes a first panel 124 and an opposing second panel 126 In one embodiment first panel 124 and second panel 126 are secured together as is known in the art. In one embodiment first panel 124 and second panel 126 may be sonically welded, stitched with a thread material, chemically bonded with an adhesive or any other method known in the art. In one embodiment first panel 124 and second panel 126 are formed from a single piece of material that is folded over along one edge. The interior compartment of second 114 is defined by the space between the first panel 124 and the second panel 126. A top opening 128 is defined by the upper edge 130 of first panel 124 that extends from and away from rear portion 126. In one embodiment, second pouch 114 includes a flap 132 extending from second panel 126 and extends over and covers opening 128 and an upper region of first panel 124.

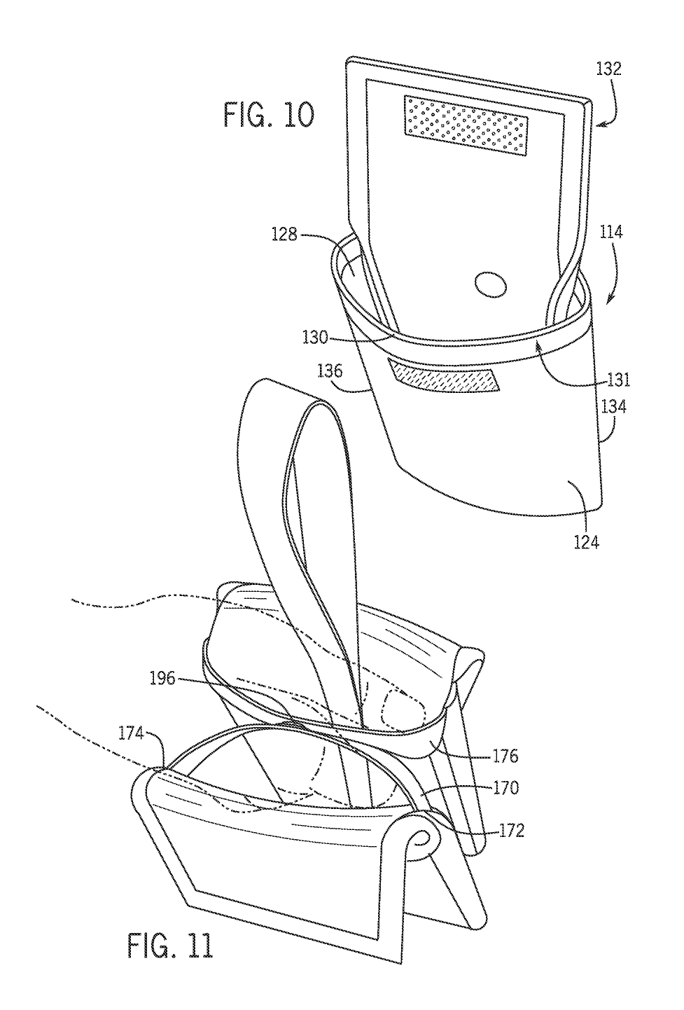

Referring to FIG. 10, upper edge 130 defining opening 128 has a curved lip 131 proximate an upper portion of the first panel 124. The curved lip 131 is formed by the dimensions of the first panel 124 being different from the dimensions of the second panel 126. In one embodiment the width of the first panel 124 as measured from a first edge 134 to a second edge 136 is greater than the width of second panel 126 as measured from first edge 134 to second edge 136. In one embodiment the flexible material forming the first panel has sufficient rigidity and form memory to create an arcuate shape of the upper lip 130 when flap 132 is in the open raised position where a user can gain access to the interior of second pouch 114 through opening 128. In one embodiment a hem of the same or different material may be adhered to the upper lip 130 to provide a finished appearance and/or provide a stronger upper edge to resist damage to the material of first pouch and/or second pouch.

Flap 122 and Flap 132 are movable between a closed position in which the flap covers the opening and the upper region of first panel 116 and 124 of first pouch 112 and second pouch 114 respectively and an open position in which flap 122 and flap 132 does not cover the respective openings of first pouch 112 and second pouch 114.

Referring to FIGS. 4 and 9, first pouch includes a disposable bag storage compartment 140 is defined by at least a portion of the interior compartment of the first pouch. In one embodiment the interior compartment of the first pouch 112 includes a first region 180 for storing a personal item such as a cell phone. The first region extends from the opening 120 substantially the entire length of the first pouch toward a bottommost portion 142. In one embodiment the interior compartment of the first pouch includes a second region 182 defining the bag storage compartment. The second region 182 extends from the bottommost portion 142 a set distance toward the opening 120. Bag storage compartment 140 includes an opening 144 providing a pathway through first panel 116 and the interior of the bag storage compartment. In one embodiment opening 144 is in a direction opposite of the top opening 120 in first pouch 112, when first pouch and second pouch are operatively secured to one another.

In one embodiment opening 144 is defined by a circular grommet 148 having an outer ring operatively secured to the first panel 116 and a center opening through which bags 146 may be pulled. In one embodiment grommet has a smooth annular surface defining the center opening on that the disposable bags 146 may easily exit the bag storage compartment.

In one embodiment bag storage compartment 140 has an opening 184 proximate bottom most portion 142 that allows a user to insert a roll of disposable bags into bag storage compartment 140. Opening 142 may be releasably closed with a fastener such as a hook and loop material or other mechanical fasteners adjacent opening 142. Second compartment 182 is defined by first panel 116 and an intermediate wall portion 186.

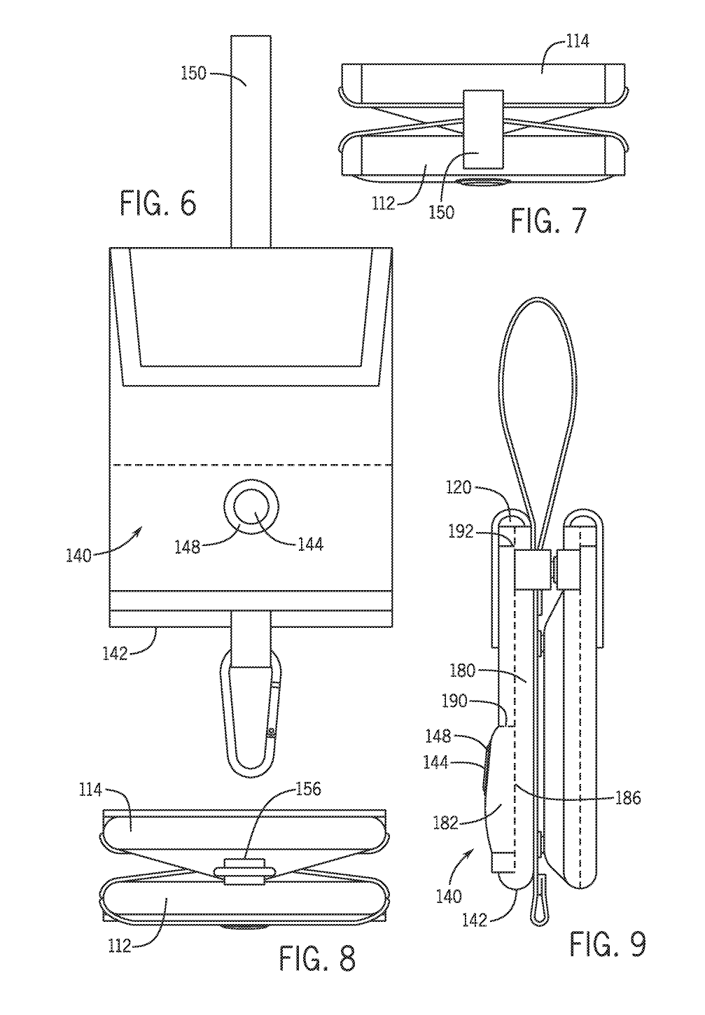

Referring to FIGS. 6 and 9, second compartment 182 includes an upper portion 188 that is separated from the bag storage compartment 140 along a line 190. The upper portion 188 has an upper opening 192 to allow a user to insert and remove a personal item including but not limited to identification card or money. The upper portion 188 is defined by an upper portion of intermediate member 186 and first panel 116 above line 190. Line 190 may be formed by a threaded stick or other type of bond that acts to separate upper potion 188 from bag storage compartment 140.

Referring to FIGS. 4 and 5 first pouch 112 includes a handle 150 having a handle grip portion 152 and an extension portion 154 extending therefrom, the extension portion 154 being secured to the second panel 118 of first pouch 112. Extension portion 154 having a terminal end 156 distal from the handle grip portion releasably securable to a pet leash through a fastener 158 such as a carabiner or other fasteners known in the art.

In one embodiment extension portion 154 is secured to second panel 118 by stitching the extension portion along its lateral edges 160, 162. In one embodiment extension portion 154 is secured to second panel 118 with grommets or other mechanical fasteners. In one embodiment extension portion 154 includes a snap fit fastener that mechanically releasably fastens the second panel 118 to the extension portion 154.

Referring to FIG. 5 second pouch 114 is releasably secured to the extension portion 154 of handle 150 with fasteners 164 having a male portion 166 and a female portion 168. Where one of the male portion 166 is secured to second panel 126 of second pouch 114 and extension portion 154 and the female portion 168 is secured to the other of the of second panel 126 of second pouch 114 and extension portion 154.

Referring to FIGS. 5 and 11, second pouch 114 includes a second handle strap 170 having a first end 172 and a second end 174 secured to the second panel 126 of second pouch 114. Second handle strap 170 has a longitudinal axis that extends between the first end 172 and second end 174. In the non-use position the longitudinal axis of second handle strap 170 is perpendicular to a longitudinal axis of extension portion 154 defined by the vector extending from handle portion 152 to distal end 156. In one embodiment second handle strap 170 is adjacent second panel 126. In the in-use position in which a portion of a user's hand is between second cross strap 170 and second panel 126, second cross strap 170 has an arcuate shape.

First pouch 112 includes a first cross handle strap 176 proximate the upper portion of second panel 118. First cross handle strap 176 is configured to receive a portion of a user's hand between first cross handle strap 176 and second panel 118 of first pouch 112. First cross handle strap 176 includes a first end 192 and a second end 194 secured to the rear region of the first pouch, the first cross handle strap 176 is adjacent and parallel to the second cross handle strap 170 when first pouch 112 is secured to second pouch 114.

Referring to FIG. 11, first cross handle strap 176 and the second cross handle strap 170 are configured to receive a portion of a user's hand between the first handle strap 176 and the second panel of the first pouch 112 and between the second handle strap 170 and the second panel of the second pouch 114. In one embodiment first handle cross strap 176 is releasably secured to second cross handle strap 170 by a fastener 196. In one embodiment, fastener 196 is a mechanical fastener positioned intermediate ends 172 and 174 of second cross strap 170 and ends 192 and 194 of first cross strap 176. Securing first cross strap to second cross strap provides a more stable handle for a user to be able grasp the modular leash system 110.

Referring to FIG. 1 pet leash 15 includes a first side facing accessory pouch 15 and an opposing side facing waste pouch 20 the first side including a first fastener portion 14a secure the accessory pouch thereto, the second side including a second fastener 17a to releasably secure the waste pouch thereto.

In one embodiment first fastener 14a and the second fastener 17 are located intermediate a first handle end of the pet leash and a distal connection end of the pet leash, the connection end of the pet leash having a fastener 12 to connect to an animal restraint secured to the animal's body.

In one embodiment second panel 118 of first pouch 112 is adjacent second panel 124 of second pouch 114 when first pouch 112 and second pouch 114 are secured to one another.

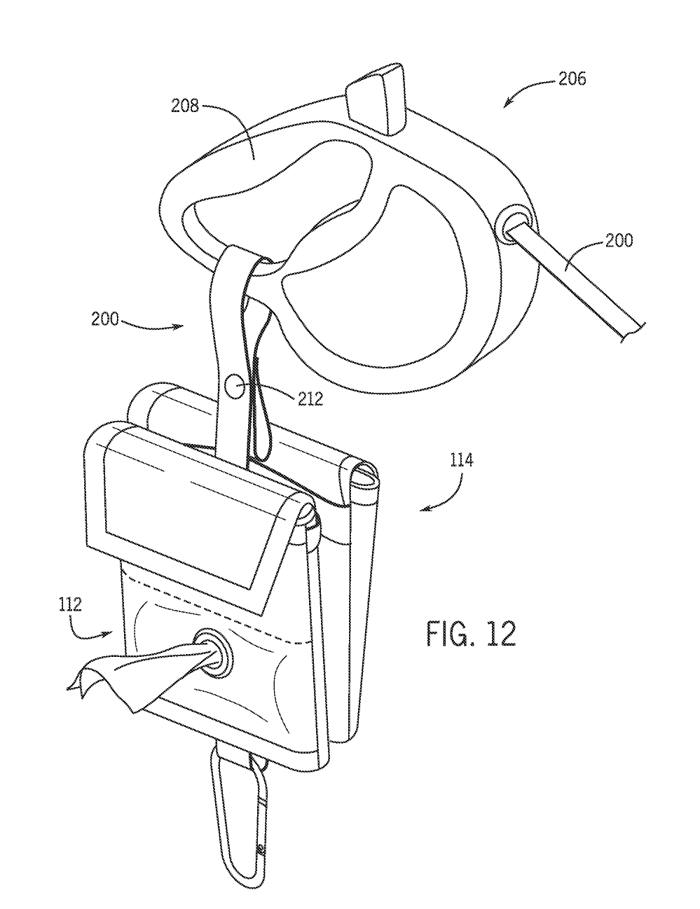

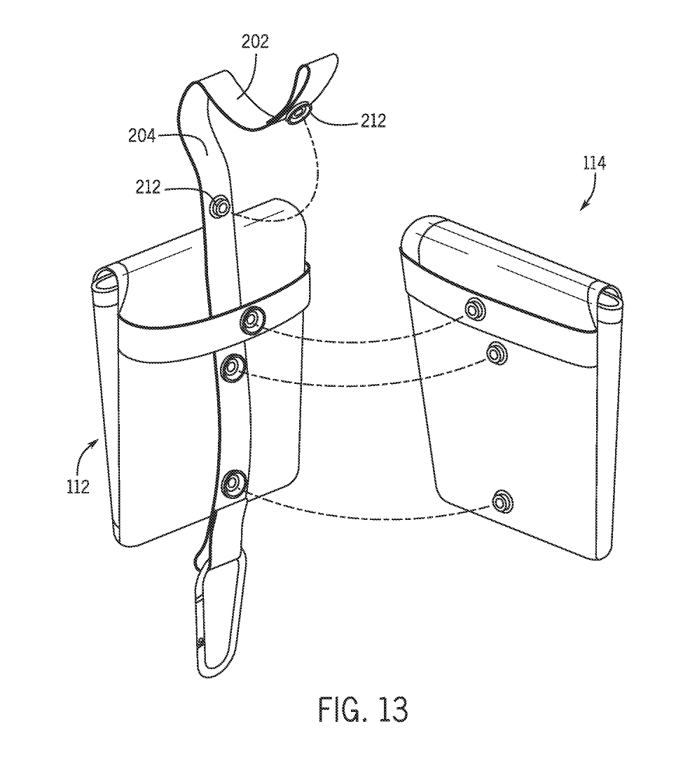

Referring to FIGS. 12 and 13 in one embodiment a handle 200 is formed from a first portion 202 and a second portion 204 that can be releasably connected to secure the handle 200 to a retractable leash 206. First portion 202 and second portion 204 are secured to one another by a mechanical fastener 212. In this embodiment the modular leash system is suspended from a handle portion 208 of retractable leash 206 and is not directly connected to the animal. Rather retractable leash portion 210 that is retractable within the housing of retractable leash 206 is directly connected to an animal restraint such as a collar worn about the animal's neck.

As discussed above, first pouch 112 and second pouch 114 are formed from a flexible and stretchable material. In one embodiment the flexible material is neoprene. In one embodiment, the flexible material has a form shape retention memory when the flap is moved from the closed position to the front position, the opening defining a wide mouth region when the flap is moved to the open position. The form shape retention allows the opening of the second pouch for example to provide a curved arcuate opening to aid in the insertion of a disposable plastic bag containing animal waste. The spring like opening of the second pouch allows a user to insert the disposable plastic bag containing animal waste without the need to hold open the first panel from the second panel. In one embodiment an additional mechanical spring may be secured to the upper region of panel 126 proximate opening 128 to aid in the opening of second pouch 114. In one embodiment first panel is formed of a neoprene material having sufficient thickness to provide a puckering effect to ensure that the first panel 124 is a distance from second panel 126 when flap 132 is in the open position. In one embodiment the thickness of the neoprene material is between 1.5 and 2.5 mm and in one embodiment the thickness of the neoprene material is 2.0 mm.

In one embodiment neoprene is a material from a family of synthetic rubbers that are produced by polymerization of chloroprene.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. Any of the features, elements, or components of any of the exemplary embodiments discussed above may be used alone or in combination with any of the features, elements, or components of any of the other embodiments discussed above. It is to be understood that the forms of the invention shown and described herein are to be taken as presently preferred embodiments. Elements and materials may be substituted for those illustrated and described herein, parts and processes may be reversed, and certain features of the invention may be utilized independently, all as would be apparent to one skilled in the art having the benefit of this description of the invention. Changes may be made in the elements described herein without departing form the spirit and scope of the invention as described in the following claims.

What is claimed is:

1. A modular leash accessory system comprising:
a first pouch having an interior compartment and an exterior surface, the first pouch being securable to an animal leash; and
a second pouch having an interior compartment releasably and operatively secured to the first pouch.

2. The apparatus of claim 1, wherein at least one of the first pouch and second pouch is formed from a flexible material.

3. The apparatus of claim 1, wherein the interior compartment of the second pouch is defined by a first region and a second region, and includes an opening having a curved lip proximate an upper portion of the first region.

4. The apparatus of claim 1, wherein the second pouch includes a flap extending from the second region and movable between a closed position in which the flap covers the opening and a portion of the first region and an open position in which the flap does not cover the opening.

5. The apparatus of claim 4, wherein the curved lip is curved when the flap is in the open position.

6. The apparatus of claim 1, wherein the first pouch includes a bag opening extending from the interior compartment of the first pouch through a first region of the first pouch, wherein disposable plastic bags stored in the interior compartment of the first pouch are retrievable through the bag opening.

7. The apparatus of claim 6, wherein the first pouch includes a second interior compartment separate from the first interior compartment to carry therein at least one of a key, phone, identification card, and money.

8. The apparatus of claim 7, wherein the first pouch includes a handle having a handle grip portion and an extension portion extending therefrom, the extension portion being secured to the second region of the first pouch, the extension portion having a terminal end distal from the handle grip portion releasably securable to a pet leash.

9. The apparatus of claim 8, wherein the second pouch is releasably secured to the extension portion of the handle.

10. The apparatus of claim 8, wherein the second pouch includes a second cross handle strap having a first end and a second end secured to the second region of the second pouch, The second cross handle strap having a longitudinal axis extending between the first and second end that is perpendicular to a longitudinal axis of the extension portion, wherein the second cross handle strap is proximate the opening of the second pouch and configured to receive a human hand between the second handle strap and the second portion of the second pouch.

11. The apparatus of claim 10, wherein the first pouch includes a first cross handle strap having a first end and a second end secured to the second region of the first pouch, the first cross handle strap being adjacent and parallel to the second cross handle strap when the first pouch is secured to the second pouch, the first cross handle strap and the second cross handle strap being configured to receive a portion of a human hand between the first cross handle strap and the second region of the first pouch and between the second cross handle strap and the second region of the second pouch.

12. The apparatus of claim 11, wherein the first handle strap is releasably secured to the second handle strap.

13. The apparatus of claim X, wherein the bag compartment includes an opening that is in a direction opposite of the top opening in the first pouch, when first pouch and second pouch are operatively secured to one another.

14. The apparatus of claim 1 including a pet leash having a first side and an opposing side, the first side including a first fastener portion to releasably secure the first pouch thereto, the second side including a second fastener portion to releasably secure the second pouch thereto.

15. The apparatus of claim 14, wherein the first fastener and the second fastener are located intermediate a first handle end of the pet leash and a distal connection end of the pet leash, the connection end of the pet leash having a fastener to connect to an animal restraint secured to the animal's body.

16. The apparatus of claim 15 wherein the handle includes a first portion and a second portion that can be releasably connected to secure the handle to a retractable leash.

17. The apparatus of claim 2, wherein first pouch and the second pouch are formed of a flexible and stretchable material.

18. The apparatus of claim 17 wherein the flexible material is neoprene.

19. The apparatus of claim 18, wherein the flexible material has a form shape retention memory when the flap is moved from the closed position to the front position, the opening defining a wide mouth region when the flap is moved to the open position.

20. The apparatus of claim 19 wherein the flexible, stretchable material is machine washable safe.
